(19) United States
(12) Patent Application Publication
(10) Pub. No.: US 2004/0074736 A1
(43) Pub. Date: Apr. 22, 2004

(54) Coin ejection unit of coin dispenser

(75) Inventor: Wen Fu Yang, Taipei City (TW)

Correspondence Address: BACON & THOMAS, PLLC, 625 SLATERS LANE, FOURTH FLOOR, ALEXANDRIA, VA, 22314

(73) Assignee: International Currency Technologies Corporation, Taipei (TW)

(21) Appl. No.: 10/274,858

(22) Filed: Oct. 22, 2002

(51) Int. Cl. G07F 5/00; G07F 11/00; G07F 13/00; G07F 15/00; G07F 17/00

(52) U.S. Cl. 194/250

(57) ABSTRACT

The coin ejection unit comprises a case, a motor set, a plurality of ejecting plates, and coin storage canister. The case comprises a base, bottom cover and a rear plate, and a base portion comprising a plurality of coin hoppers. A motor set is attached on a side of the base portion. The motor rotates a dispensing axel, the biasing rollers presses against the corresponding buckling plates of the pulling plates to press the buckling plates inside the corresponding indented grooves of the sliding element, meanwhile the biasing roller of the motor case will make the connecting bar to move backward and forward pulling the sliding element and the pulling plate outwardly, as a result the blocking portion of the pulling plate will pull out a lower most coin stored in the coin magazines.

### BACKGROUND OF THE INVENTION

1. Field of the Invention

The present invention relates to a coin ejection unit of a coin dispenser, and more particularly, the present invention relates to a coin ejection unit comprising a motor set to make a connecting bar to move forward and backward which in turn will make a sliding element set and the pulling plate to move outwardly and horizontally to pull out the coins stored inside the coin storage canister.

2. Description of the Related Art

Due to the rapid advancement in technologies, a greater need for an improved and good quality automatic vending machines such as merchandising vending machine, ticketing vending machine and auto-coin exchanger that are commonly installed in public facilities for publics' convenience and prompt service. The use of these vending machines could substantially reduce the labor cost. The convenience offered by these machines indeed increases the acceptance from users. The above-mentioned vending machines comprise a coin ejection unit for ejecting the change coins back to the user after the use inserts the coins into the vending machine to pay for the merchandise. Referring to FIGS. 6 and 7, a conventional coin ejecting unit A comprises a chassis A1, a coin storage canister A2 positioned above the chassis A1, a pad A3 positioned at a exit of the coin storage canister A2. A solenoid device B is disposed on a side of the chassis A1. The solenoid device B comprises an electromagnetic switch B1 which is surrounded by a resilient element B11, and a solenoid plunger B2 is positioned in front of the electromagnetic switch B1. The free end of the plunger B2 is positioned horizontally in a gap between a bottom of the coin storage canister A2 and the pad A3, in this position, the plunger B2 blocks a coin C from falling onto the pad A3. As the solenoid device B is electrically energized, the solenoid device B is turned on, the electromagnetic switch B1 is moved backward, as a result the solenoid plunger B2 is also moved backward, in doing so, the coin C inside the coin storage canister A2 falls onto the pad A3 due to gravitational force. When the electric power supply to the solenoid device B is turned off, due to the elasticity of the resilient element B11 of the electromagnetic switch B1 is pushed forward, as a result, the solenoid plunger B2 is moved forward to strike the coin C off the pad A3 and into the coin chute. Thus the coin C is ejected out from the coin storage canister A2 into coin chute of the vending machine. However, the above-mentioned conventional design has several defects described as follows.

1) When the conventional coin ejection unit A need to eject a large quantity of coins C, the electromagnetic switch B1 is required to move backward and forward repeatedly, accordingly, the power supply to the solenoid device B of the coin ejection unit A has to turned on and turned off repeatedly in a short duration of time. Thus, the solenoid device B could get easily damaged.

2) As the electromagnetic switch B1 is turned on and off repeatedly, and since the output force each time the electromagnetic switch B1 is turned on and off is not same, thus about 90% of the electric power is exhausted, this results in a larger consumption of electric power. Thus the operating cost is high.

Accordingly, a new improved cost effective coin ejection unit is highly desirable.

### SUMMARY OF THE INVENTION

Accordingly, in the view of the foregoing, the present inventor makes a detailed study of related art to evaluate and consider, and uses years of accumulated experience in this field, and through several experiments, to create a coin ejection unit of the present invention. The present invention provides an innovated cost effective coin ejection unit of a coin dispenser.

Accordingly, it is an object of the present invention to provide a coin ejection unit, which can be operated with higher reliability and less power consumption compared to the conventional coin ejection unit.

It is another object of the present invention to provide an ejection mechanism for ejecting the coins more easily and accurately than the conventional coin ejection unit.

In order to achieve the above objects and other objects of the present invention, a coin ejection unit of a coin dispenser is provided. The coin ejection unit comprises a case, a motor set, a plurality of pulling plates, and coin storage canister. The case comprises a base, bottom cover and a rear plate, and a base portion comprising a plurality of coin hoppers. Each of the coin hoppers comprises a guiding groove that extend from it. A coin dispensing slot is positioned at a central region of the bottom cover. The motor set comprises a positioning plate attached on a side of a base portion. A motor case is positioned on the base portion, and a motor positioned on the positioning plate. The two sides of the motor case are connected by a biasing roller and a connecting bar. An aperture is disposed at a distal end of the connecting bar. The connecting bar is positioned within the sliding element that comprises a plurality of indented grooves. A sliding axle penetrates through the sliding element and the aperture of the connecting bar. The positioning plate comprises an axially mounted dispensing axle. The dispensing axle comprises a plurality of biasing rollers, which are disposed spaced apart from each other at predetermined positions and rotates biasing in an orderly fashion. The motor drives to rotate the dispensing axel.

A plurality of pulling plates is disposed inside the base portion of the case with each of the pulling plates positioned under the corresponding coin hopper. A buckling plate pivotally engaged with each of the pulling plates through a connecting element on one side, a blocking portion projecting upwardly on the other side, and an aperture is disposed on a surface of the pulling plate. The coin canister comprises a plurality of coin magazines.

According to an aspect of the present invention, the motor set is positioned inside the base of the case, and the pulling plates are disposed inside the base portion of the case in a such a manner that the blocking portion of the pulling plate projects out of the corresponding guiding groove of the coin hopper.

According to another aspect of the present invention, the biasing rollers of the dispensing axel are positioned on an upper part of the corresponding buckling plates of the pulling plates. The bottom cover and rear plate are detachably assembled at a bottom and rear side of the base respectively. The coin canister is mounted onto the base portion of the base, with the coin magazines of the coin canister aligned with the coin hoppers.

According to another aspect of the present invention, after a coin is inserted into an insertion slot of the coin dispenser, the coin will be stored into the coin magazines of the coin canister in an orderly fashion. This will trigger the coin ejection unit to eject the coin, for doing this, the motor of the motor set will be activated to rotate the dispensing axel and this will in turn rotate the biasing rollers that are set at predetermined angles to press against the buckling plate of the pulling plate to press down the buckling plate, as a result, the buckle plate rotates along the sliding axel and is pressed inside the indented groove of the sliding element, meanwhile the biasing roller of the motor case will make the connecting bar to move backward and forward pulling the sliding element and the pulling plate outwardly, as a result the blocking plate of the pulling plate will pull out the lower most coin stored in the coin magazine. In addition, when the pulling plate moves outwardly, the aperture of the pulling plate aligns with the coin dispensing slot of the bottom cover, thus the coin will fall through the aperture of the pulling plate and the coin dispensing slot of the bottom cover and into the coin chute of the coin dispenser.

### BRIEF DESCRIPTION OF THE DRAWINGS

FIG. 1 is an exploded view of a coin dispenser including a coin ejection unit of the present invention;

FIG. 2 is an elevational view of the coin dispenser including the coin ejection unit of the present invention;

FIG. 3 is an exploded view of the coin ejection unit of the present invention;

FIG. 4 is an embodiment of the coin ejection unit showing a motor set and a pulling plate according to the present invention;

FIG. 5 is a sectional side view of the coin dispenser while in operation according to the present invention (I);

FIG. 5A is a sectional side view of the coin dispenser while in operation according to the present invention (II);

FIG. 5B is a sectional side view of the coin dispenser while in operation according to the present invention (III);

FIG. 5C is a sectional side view of the coin dispenser while in operation according to the present invention (IV);

FIG. 6 is a side sectional view of a conventional coin dispenser; and

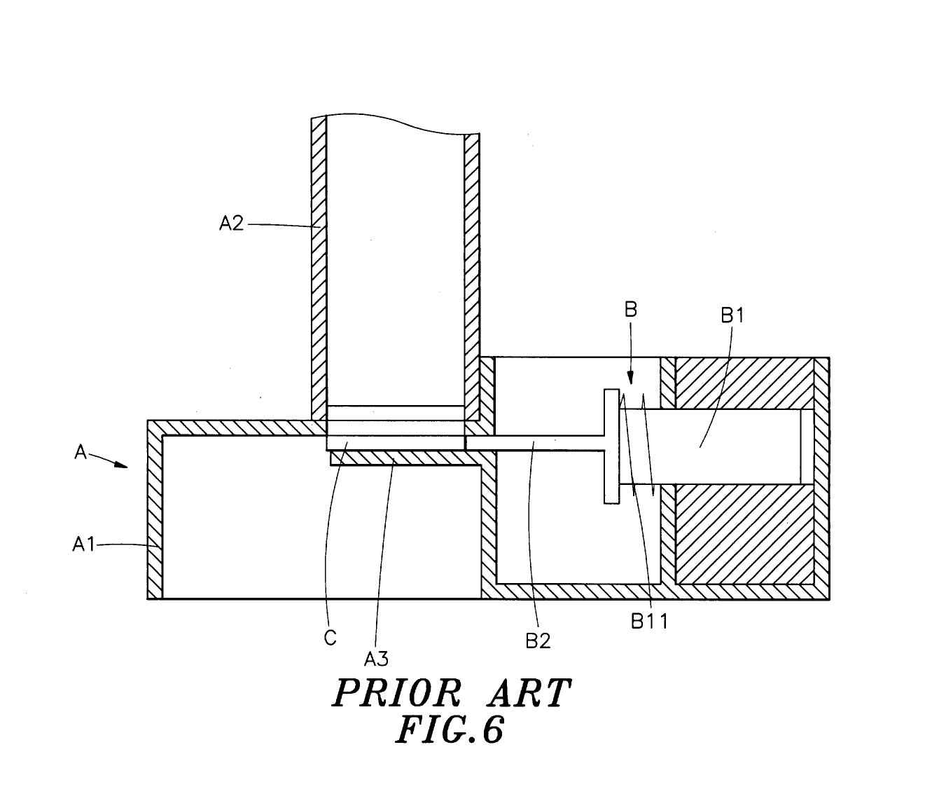

FIG. 7 is another side sectional view of the conventional coin dispenser.

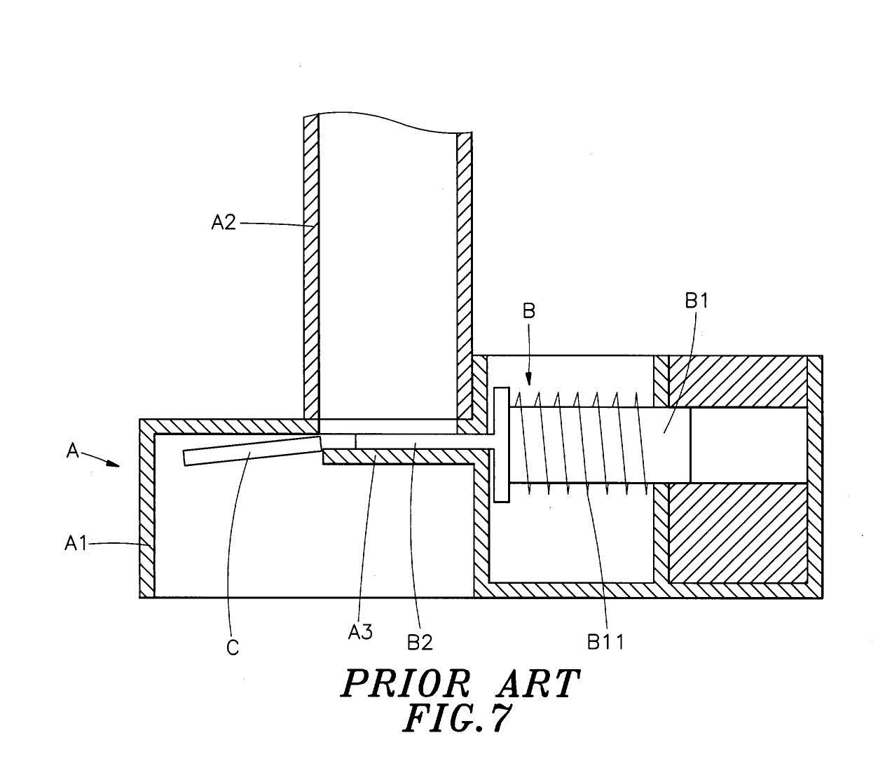

### DESCRIPTION OF THE PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

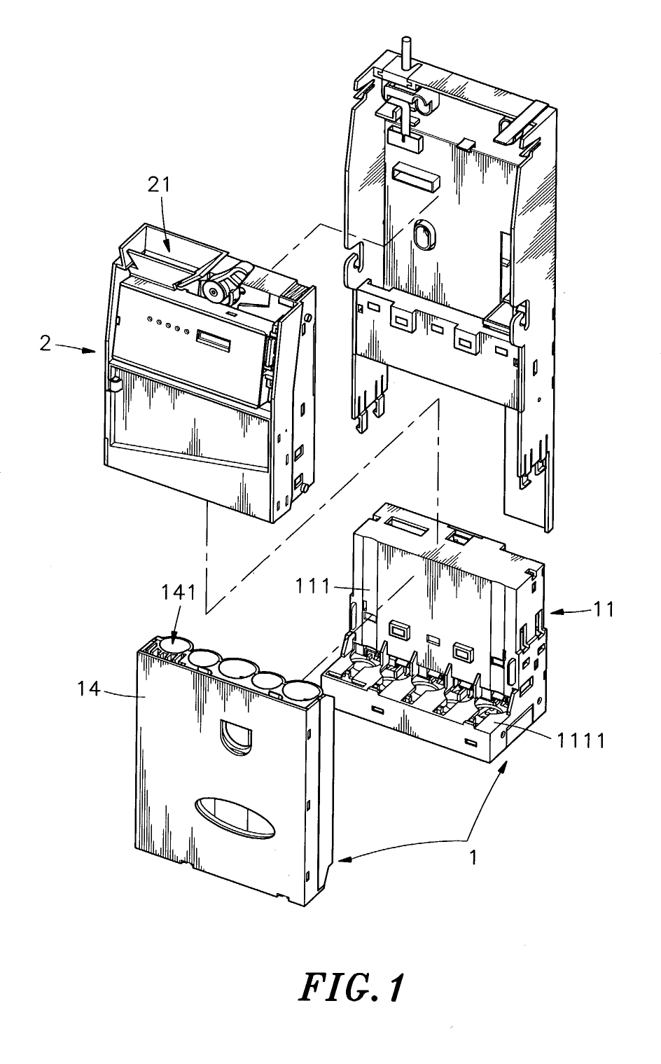

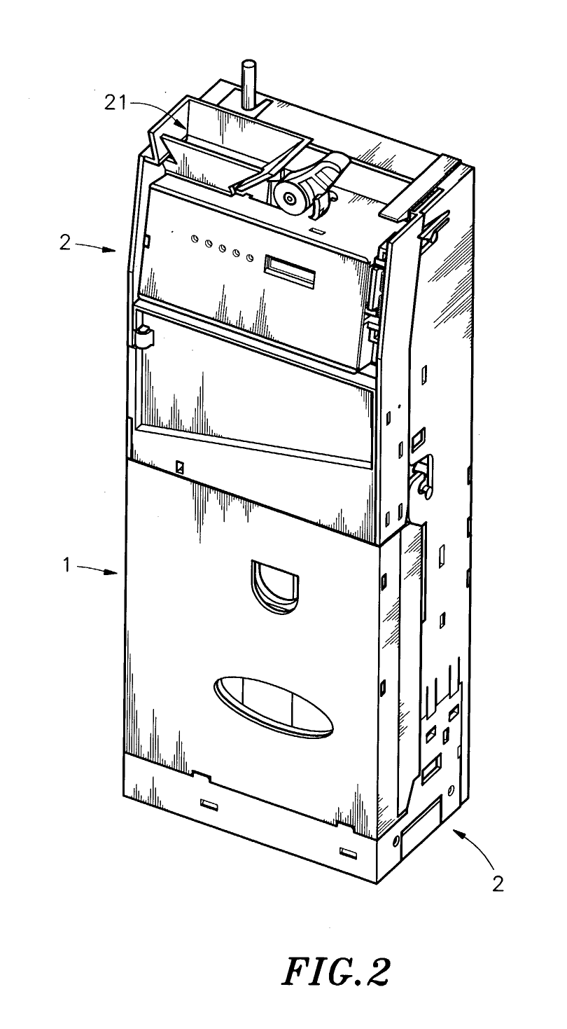

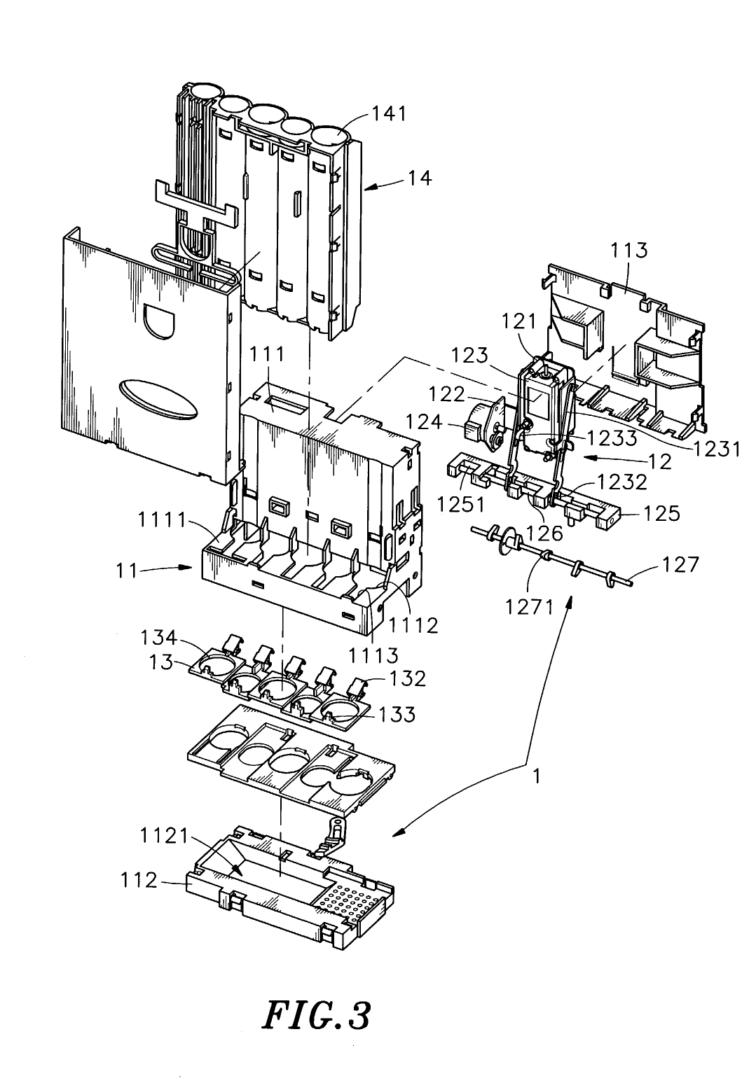

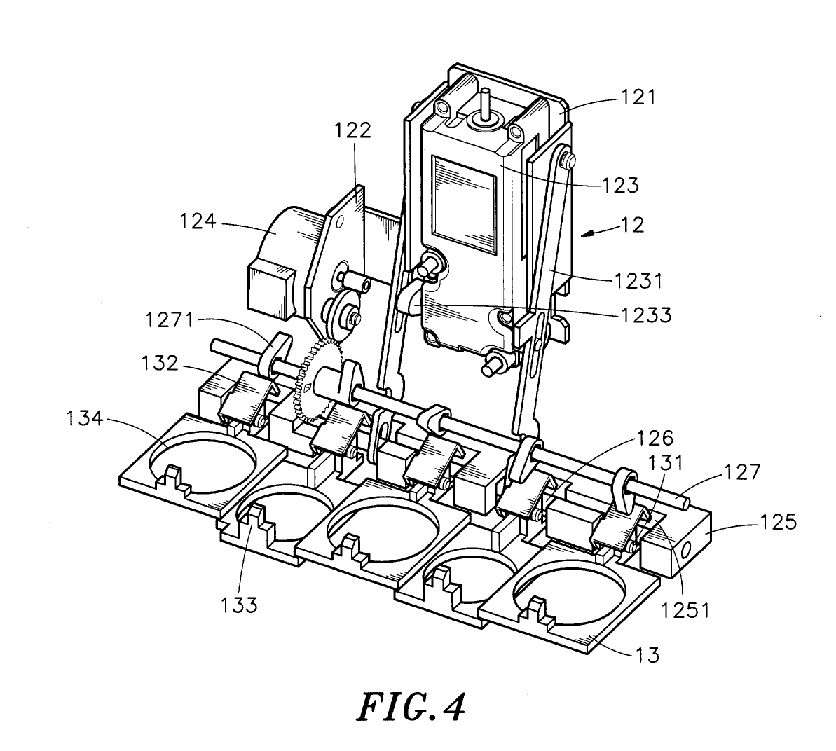

Referring to FIGS. 1, 2, 3 and 4, a coin ejection unit 1 comprises a case 11, motor set 12, a plurality of pulling plates 13 and coin storage canister 14. The case 11 comprises a base 111, bottom cover 112 and a rear plate 113, and a base portion 1111 comprising a plurality of coin hoppers 1112. Each of the coin hoppers 1112 comprises a guiding groove 1113 which extend from it. A coin dispensing slot 1121 is positioned at a central region of the bottom cover 112.

The motor set 12 comprises a positioning plate 122 attached on a side of a base portion 121. A motor case 123 is positioned on the base portion 121, and a motor 124 positioned on the positioning plate 122. The motor 124 can be a piston motor. The two sides of the motor case 123 are connected by a biasing roller 1233 and a connecting bar 1231. An aperture 1232 is disposed at a distal end of the connecting bar 1231. The connecting bar 1231 is positioned within the sliding element 125 that comprises a plurality of indented grooves 1251. A sliding axle 126 penetrates through the sliding element 125 and the aperture 1232 of the connecting bar 1231. The positioning plate 122 comprises an axially mounted dispensing axle 127. The dispensing axle 127 comprises a plurality of biasing rollers 1271 which are disposed spaced apart from each other at predetermined positions and rotates biasing in an orderly fashion. The motor 124 drives to rotate the dispensing axel 127.

A plurality of pulling plates 13 is disposed inside the base portion 1111 of the case 11 with each of the pulling plates 13 positioned under the corresponding coin hopper 1112. A buckling plate 132 pivotally engaged with each of the pulling plates 13 through a connecting element 131 on one side, a blocking portion 133 projecting upwardly on the other side, and an aperture 134 is disposed on a surface of the pulling plate 13.

The coin canister 14 comprises a plurality of coin magazines 141.

The motor set 12 is positioned inside the base 111 of the case 11, and the pulling plates 13 are disposed inside the base portion 1111 of the case 11 in a such a manner that the blocking portion 133 of the pulling plate 13 projects out of the corresponding guiding groove 1113 of the coin hopper 1112. The biasing rollers 1271 of the dispensing axel 127 are positioned on an upper part of the corresponding buckling plates 132 of the pulling plates 13. The bottom cover 112 and rear plate 113 are detachably assembled at a bottom and rear side of the base 111 respectively. The coin canister 14 is mounted onto the base portion 1111 of the base 111, with the coin magazines 141 of the coin canister 14 aligned with the coin hoppers 1112. Thus the assembly of the above-mentioned coin ejection unit 1 of the present invention that is positioned at a lower part of a coin dispenser 2 is completed.

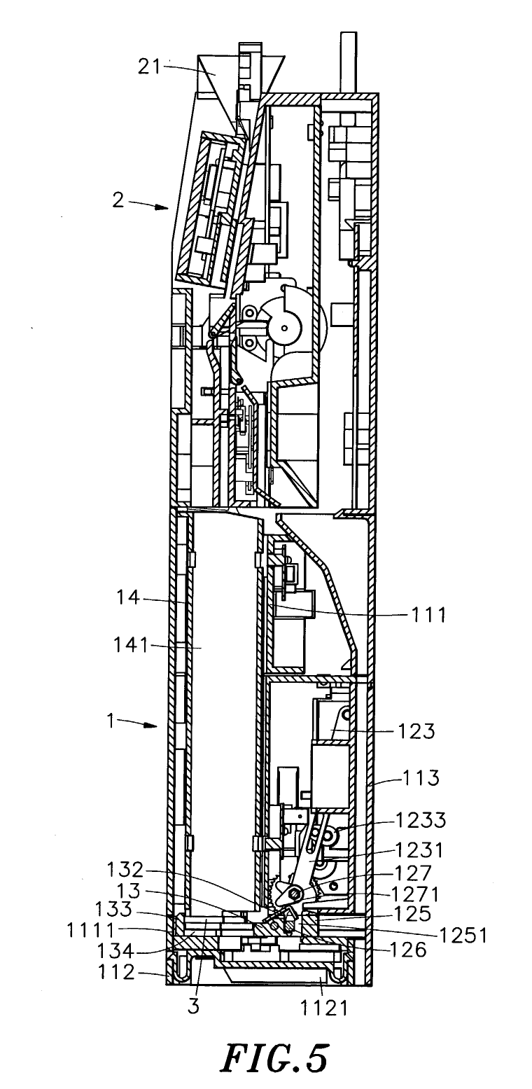

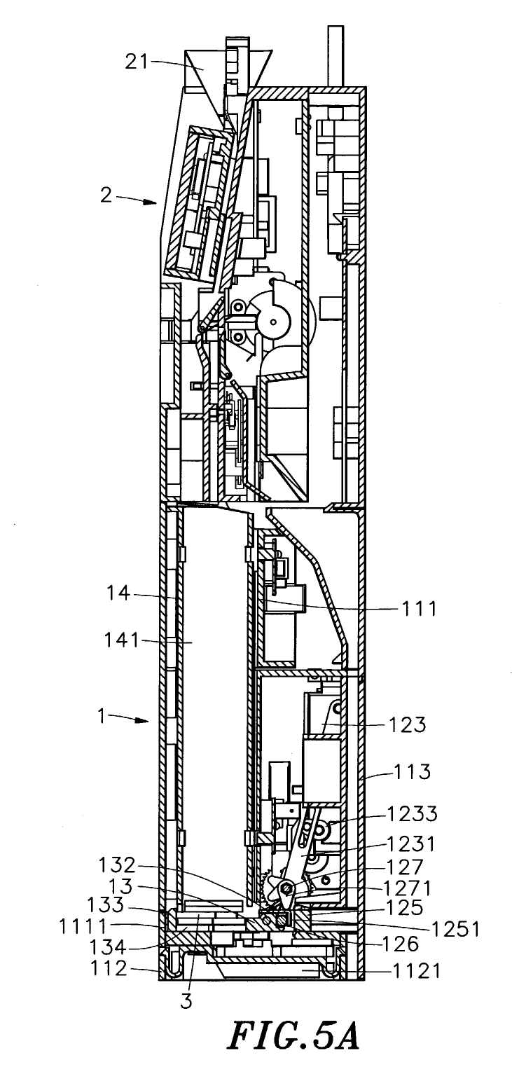

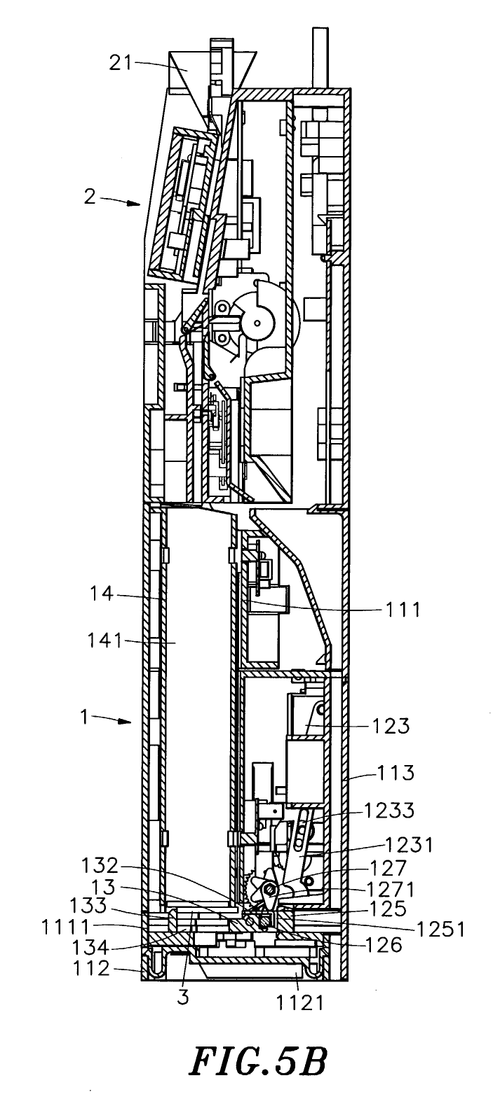

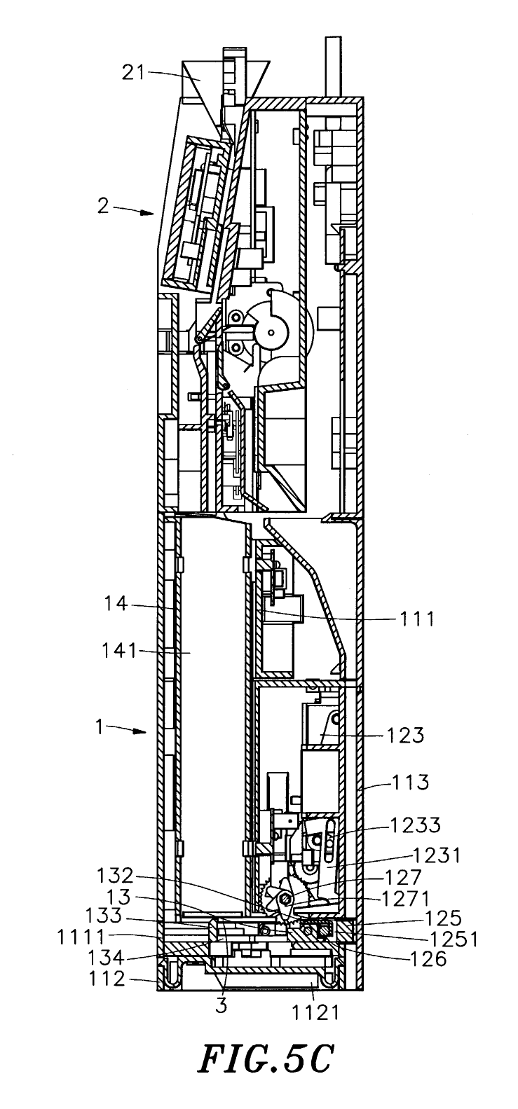

Referring to FIGS. 5, 5A, 5B and 5C, the actual operation of the coin dispenser 2 of the present invention is described as follows. After a coin 3 is inserted into an insertion slot 21 of the coin dispenser 2, the coin 3 will be stored into the coin magazines 141 of the coin canister 14 in an orderly fashion. After the coin 3 is stored inside the coin canister 14, the coin dispenser 2 will allow the user to select the merchandise. Upon selection of the merchandise, the coin ejection unit 1 will eject the coin 3 for returning the change to the user, for doing this, the motor 124 of the motor set 12 will be activated to rotate the dispensing axel 127 and this will in turn rotate the biasing rollers 1271 that are set at predetermined angles to press against the buckling plate 132 of the pulling plate 13 to press down the buckling plate 132, as a result, the buckle plate 132 rotates along the sliding axel 126 is pressed inside the indented groove 1251 of the sliding element 125, meanwhile the biasing roller 1233 of the motor case 123 will make the connecting bar 1231 to move backward and forward pulling the sliding element 125 and the pulling plate 13 outwardly, as a result the blocking portion 133 of the pulling plate 13 will pull out the lower most coin 3 stored in the coin magazines 141. In addition, when the pulling plate 13 moves outwardly, the aperture 134 of the pulling plate 13 aligns with the coin dispensing slot 1121 of the bottom cover 112, thus the coin 3 will fall through the aperture 134 of the pulling plate 13 and the coin dispensing slot 1121 of the bottom cover 112 and into the coin chute of the coin dispenser 2, and thus accomplishing ejection of the coin 3 from the coin canister 14.

While the invention has been described in conjunction with a specific best mode, it is to be understood that many alternatives, modifications, and variations will be apparent to those skilled in the art in light of the a foregoing description. Accordingly, it is intended to embrace all such alternatives, modifications, and variations, which fall within the spirit and scope of the included claims. All matters set forth herein or shown in the accompanying drawings are to be interpreted in an illustrative and non-limiting sense.

What the invention claimed is:

1. A coin ejecting unit of a coin dispenser, comprising:
a case comprising a base, a bottom cover and a rear plate, wherein the base comprises a base portion, and a plurality of coin hoppers are disposed on said base portion;
a motor set is positioned inside the base of the case, a motor case and a motor are positioned on a base portion where said motor set located, a connecting bar and a sliding element are axially engaged on two sides of the motor case, wherein the sliding element is disposed at a distal end of said connecting bar, and wherein said motor drives to rotating a dispensing axle which comprises a plurality of biasing rollers;
a plurality of pulling plates is positioned inside the base of said case, wherein a buckling plate is axially engaged on one side of said pulling plate, and a blocking portion projecting upwardly on the other side, and an aperture is disposed on a surface of each of the pulling plates;
a coin canister is positioned on the base portion of the base, wherein the coin canister comprises a plurality of coin magazines corresponding to the plurality of coin hoppers of the base portion, wherein as the motor rotates the dispensing axel, the biasing rollers presses against the corresponding buckling plate of the pulling plate to press the buckling plate inside an indented groove of the sliding element, meanwhile the biasing roller of the motor case will make the connecting bar to move backward and forward pulling the sliding element and the pulling plate outwardly, as a result the blocking portion of the pulling plate will pull out a lower most coin stored in the coin magazines.

2. The coin ejecting unit of claim 1, wherein the bottom cover comprises a coin dispensing slot at a central region.

3. The coin ejecting unit of claim 1, wherein each of the coin hoppers comprises a leading groove.

4. The coin ejecting unit of claim 1, wherein a biasing roller is positioned in between the motor case and the connecting bar of the motor set for making the connecting bar to move backward and forward.

5. The coin ejecting unit of claim 1, wherein the sliding element comprises a plurality of indented grooves for pivotally engaging the connecting bar, and wherein an aperture is disposed at a distal end of the connecting bar, and wherein a sliding axel penetrates through the sliding element and the aperture of connecting bar.

6. The coin ejecting unit of claim 1, wherein the motor is a piston motor.

7. The coin ejecting unit of claim 1, wherein the biasing rollers of the dispensing axel are spaced apart from each other at predetermined positions and at predetermined angles for rotating the biasing rollers in an orderly fashion.

8. The coin ejecting unit of claim 1, wherein the biasing rollers of the dispensing axel face the corresponding buckling plates of the pulling plates.

9. The coin ejecting unit of claim 1, wherein the coin ejecting unit can be combined with a coin differentiating unit on an upper side.

10. The coin ejecting unit of claim 1, wherein the motor of the motor set is positioned onto the positioning plate and to a side of the base portion.
